(19) United States
(12) Patent Application Publication
(10) Pub. No.: US 2008/0136766 A1
(43) Pub. Date: Jun. 12, 2008

(54) Apparatus and Method for Displaying Image Data

(76) Inventor: George Lyons, Langley (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/608,092

(22) Filed: Dec. 7, 2006

(51) Int. Cl. G09G 3/36

(52) U.S. Cl. 345/100

(57) ABSTRACT

Pixel activation time based brightness uniformity control of a display device is disclosed. A number of pixels within the display device are identified as needing an intensity adjustment when digital image data is rendered by the display device. An activation time of the number of identified pixels is adjusted relative to other pixels within the display device during scanning of the display device to render the digital image data. The adjusted activation time causes the number of identified pixels to be visually perceived as having a correspondingly adjusted intensity.

### BACKGROUND

1. Field of the Invention

The present invention relates generally to display of digital image data.

2. Description of the Related Art

Displays such as LCD panels, CRT monitors, projectors, etc., use a light source in order to see the actual display data. Depending on the orientation of the light source relative to the display screen, e.g., edge-mounted, center-mounted, etc., there will be a difference in display intensity in different regions of the display screen. For example, a center-mounted light source in a projector will cause pixels in the center of the projected image to have higher intensity relative to pixels farther away from the center of the projected image. If the projected image is large, the intensity degradation for pixels farther away from the center of the projected image can be noticeable and undesirable.

It is preferable to have a uniform pixel display intensity across the entire displayed image. In the above-mentioned example of the projector having the center-mounted light source, one approach to compensate for center-to-edge variation in pixel intensity involves lowering the digital intensity level of the center pixels and increasing the digital intensity of the edge pixels. In this approach, the actual digital data associated with the various pixels is changed. Modification of the actual digital data can be expensive in terms of processing resources and may introduce undesirable artifacts into the displayed image. Also, in this approach the overall intensity of the displayed image is lowered in an attempt to obtain more uniform pixel display across the displayed image. In some applications, lowering of the overall intensity of the displayed image not desirable.

In view of the foregoing, a solution is needed to improve the uniformity of pixel intensity across a displayed image without modification of the actual digital image data and without lowering of the overall intensity of the displayed image.

### SUMMARY

In one embodiment, a display controller is disclosed. The display controller includes logic defined to control an activation time of separate pixels within a display device during scanning of the display device to render digital image data. An increased activation time of a given pixel causes the given pixel to be visually perceived as having an increased intensity. A decreased activation time of the given pixel causes the given pixel to be visually perceived as having a decreased intensity.

In another embodiment, a graphics engine is disclosed. The graphics engine includes a display controller defined to separately control an activation time of each line within a display device relative to other lines within the display device during scanning of the display device to render digital image data. An increased activation time of a given line causes the given line to be visually perceived as having an increased intensity. A decreased activation time of the given line causes the given line to be visually perceived as having a decreased intensity.

In another embodiment, a method is disclosed for displaying image data. The method includes an operation for identifying a number of pixels within a display device as needing an adjusted intensity when digital image data is rendered by the display device. The method also includes an operation for adjusting an activation time of the number of identified pixels relative to other pixels within the display device during scanning of the display device to render the digital image data. The adjusted activation time causes the number of identified pixels to be visually perceived as having a correspondingly adjusted intensity.

Other aspects of the invention will become more apparent from the following detailed description, taken in conjunction with the accompanying drawings, illustrating by way of example the present invention.

### BRIEF DESCRIPTION OF THE DRAWINGS

FIG. 1 is an illustration showing a display for rendering digital image data;

FIG. 2 is an illustration showing an exemplary pixelized display, in accordance with one embodiment of the present invention;

FIG. 3 is an illustration showing an exemplary pixelized display, in accordance with one embodiment of the present invention;

FIG. 4 is an illustration showing an exemplary pixelized display, in accordance with one embodiment of the present invention;

FIG. 5 is an illustration showing a system for implementing pixel activation time based brightness uniformity control, in accordance with one embodiment of the present invention; and

FIG. 6 is an illustration showing a flowchart of a method for displaying image data, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

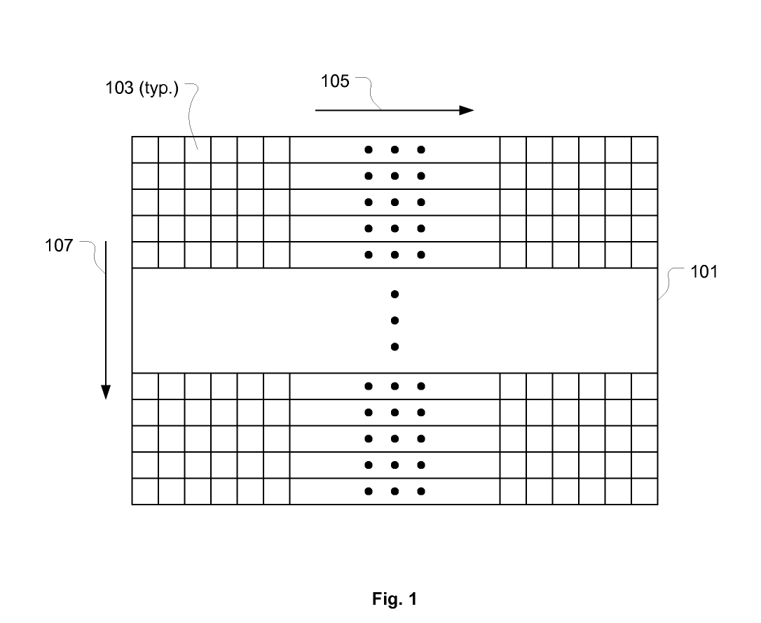

FIG. 1 is an illustration showing a display 101 for rendering digital image data. The display 101 includes a number of pixels 103 (typical) defined in a matrix configuration. Thus, the display 101 is defined by a number of rows of pixels 103, wherein each row includes the same number of pixels 103. Examples of pixelized displays, such as that shown in FIG. 1, include liquid crystal displays (LCDs), cathode ray tube (CRT) monitors, projectors, and televisions, among others. In one embodiment, such as the CRT monitor, the pixels 103 within each row of the display 101 are scanned, i.e., turned on, sequentially in a left-to-right direction 105, and the rows are scanned sequentially in a top-to-bottom direction 107. In another embodiment, such as the LCD, the pixels 103 within each row are simultaneously turned on, and the rows are scanned sequentially in the top-to-bottom direction 107.

Conventionally, each pixel 103 in the display 101 is scanned at a fixed frequency, i.e., at a fixed refresh rate. Therefore, conventionally, each pixel 103 in the display 101 is turned on for the same amount of time. Additionally, the light intensity of a given pixel 103 in the display 101 is defined by a light source of the display and the proximity of the given pixel 103 from the light source. Thus, in the conventional display, pixels that are farther away from the light source will appear to have a lower intensity with respect to pixels that are closer to the light source.

It is desirable that each pixel of the display have a substantially uniform intensity when turned on. In the present invention, to provide a uniform pixel intensity across the display, pixels that need to appear more intense, i.e., brighter, are turned on, i.e., activated, for a longer period of time relative to other pixels. Conversely, pixels that need to appear less intense, i.e., dimmer, are turned on, i.e., activated for a shorter period of time relative to other pixels. The human eye will perceive the pixels that are turned on for a longer period of time as being more intense or brighter, and pixels that are turned on for a shorter period of time as being less intense or dimmer.

Thus, to make a particular region of a display appear brighter, the pixels within the particular region of the display are turned on for a longer period of time relative to the remainder of the display. To make a particular region of a display appear dimmer, the pixels within the particular region of the display are turned on for a shorter period of time relative to the remainder of the display. For example, if the pixel activation time is controlled on a line-by-line basis, a line that needs to appear brighter can be turned on for a longer period of time in order to visually increase its level of intensity relative to other lines. Conversely, a line that needs to appear dimmer can be turned on for a shorter period of time in order to visually decrease its level of intensity relative to other lines.

It should be understood that pixel intensity adjustment via pixel activation time control does not require modification of the actual digital data associated with the pixel, wherein the digital data defines the color value of the pixel. It should be further understood that pixel intensity adjustment via pixel activation time control does not require modification of analog brightness, i.e., light source power. It should be appreciated that in various embodiments, the pixel activation time control provided by the present invention can be implemented on a line-by-line basis, a pixel-by-pixel basis, or a line segment-by-line segment basis.

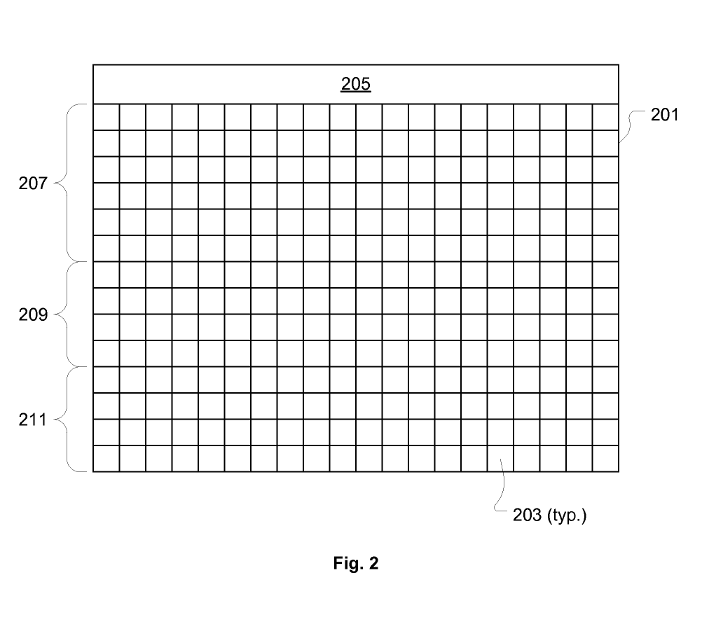

FIG. 2 is an illustration showing an exemplary pixelized display 201, in accordance with one embodiment of the present invention. The display 201 includes a number of pixels 203 (typical) defined in a matrix configuration. Thus, the display 201 is defined by a number of rows of pixels 203, wherein each row includes the same number of pixels 203. It should be understood that the size of display 201, in terms of pixel width and pixel height, is substantially small for ease of description. In reality, the width and height of a typical display may be defined by hundreds of pixels, respectively. The display 201 also includes a light source 205 positioned parallel and adjacent to the top row of pixels. Thus, without compensation, it can be expected that pixels in rows farther away from the light source 205 will have lower intensity when turned on, relative to pixels in rows closer to the light source 205.

In one exemplary embodiment of the present invention, the pixel activation time in the display 201 is controlled on a line-by-line basis to compensate for the pixel intensity variation with distance from the light source 205. More specifically, during scanning of the display 201, each line of pixels can be activated for a prescribed period of time, whereby the activation period affects the perceived visual intensity of the line of pixels. For example, the lines within portion 207 of the display 201 can be respectively activated for a first period of time. Then, the lines within portion 209 of the display 201 can be respectively activated for a second period of time that is longer than the first period of time. Then, the lines within portion 211 of the display 201 can be respectively activated for a third period of time that is longer than the second period of time. Thus, the lines farther from the light source 205 are activated for a longer period of time with respect to the lines closer to the light source 205, to compensate for the pixel intensity variation with distance from the light source 205.

For ease of description, the above example is described with regard to collective control of the lines within each of the display portions 207, 209, and 211, respectively. However, it should be understood that pixel activation time can be controlled on a line-by-line basis with each line of pixels having its own prescribed activation time that may be different from other lines.

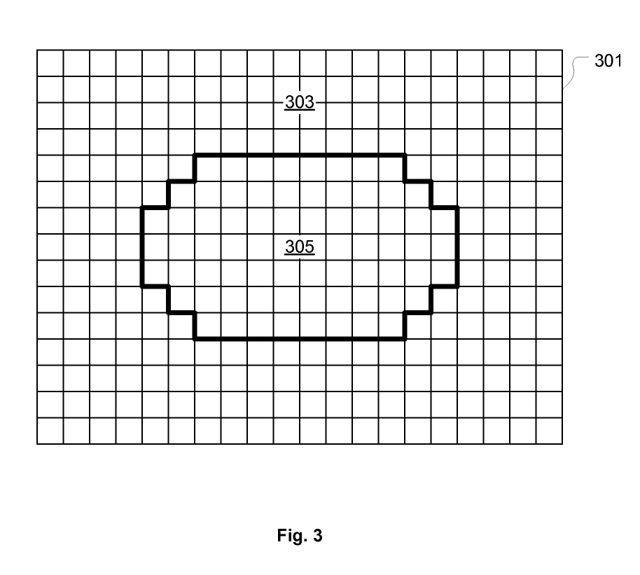

FIG. 3 is an illustration showing an exemplary pixelized display 301, in accordance with one embodiment of the present invention. The display 301 includes a number of pixels defined in a matrix configuration. In one embodiment, the activation time of the pixels within display 301 can be controlled on a pixel-by-pixel basis across the display. It should be appreciated that pixel-by-pixel activation time control provides the most extensive brightness uniformity control capability.

In one exemplary embodiment, the display 301 corresponds to a projector display having a center-mounted light source. In this embodiment, without compensation, the pixels toward the center of the display 301 will appear brighter relative to the pixels near the outer region of the display 301. In one embodiment of the present invention, the pixel activation time in the display 301 is controlled on a pixel-by-pixel basis to compensate for the center-to-edge pixel intensity variation. More specifically, during scanning of the display 301, each pixel can be activated for a prescribed period of time, whereby the activation period affects the perceived visual intensity of the pixel. For example, the pixels within portion 303 of the display 301 can be respectively activated for a longer period of time with respect to the pixels within portion 305 of the display 301, to compensate for the pixel intensity variation with distance from the center-mounted light source.

For ease of description, the above example is described with regard to collective control of the pixels within each of the display portions 303 and 305, respectively. However, it should be understood that pixel activation time can be controlled on a pixel-by-pixel basis with each pixel having its own prescribed activation time that may be different from other pixels.

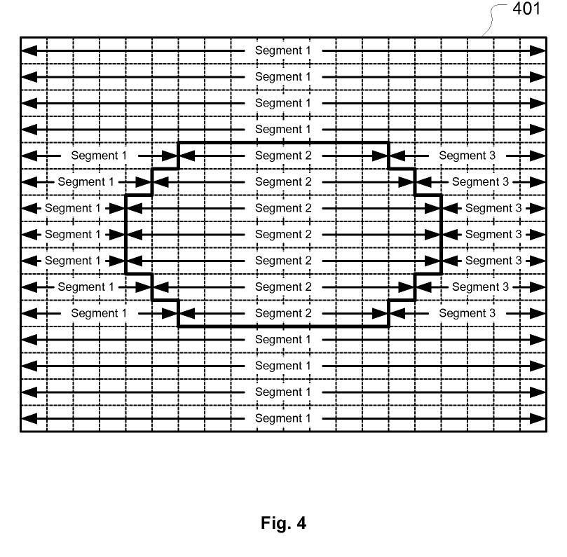

FIG. 4 is an illustration showing an exemplary pixelized display 401, in accordance with one embodiment of the present invention. The display 401 includes a number of pixels defined in a matrix configuration. In one embodiment, the activation time of the pixels within display 401 can be controlled on a line segment-by-line segment basis across the display. In this embodiment, a line segment includes a contiguous number of pixels within a line of pixels extending across the display 401. It should be appreciated that line segment-by-line segment activation time control provides a level of brightness uniformity control capability between that provided by line-by-line control and pixel-by-pixel control.

In one exemplary embodiment, the display 401 corresponds to a projector display having a center-mounted light source. In this embodiment, without compensation, the pixels toward the center of the display 401 will appear brighter relative to the pixels near the outer region of the display 401. The pixel activation time in the display 401 can be controlled on a line segment-by-line segment basis to compensate for the center-to-edge pixel intensity variation. More specifically, during scanning of the display 401, pixels within each line segment can be activated for a prescribed period of time, whereby the activation period affects the perceived visual intensity of the pixels in the line segment.

For ease of description, the above example is described with each line of pixels divided into either one line segment or three line segments. However, it should be understood that in other embodiments, each line of pixels can be divided into any number of line segments ranging from one, i.e., whole line, to the number of pixels per line, i.e., analogous to pixel-by-pixel control. Thus, the size of a line segment can range from one pixel to the total number of pixels in the line.

With regard to the embodiments of FIGS. 2-4 for line-by-line, pixel-by-pixel, and line segment-by-line segment pixel activation time control, respectively, it is necessary to provide a register for storing each required pixel activation time value. Therefore, in the embodiment for line-by-line pixel activation time control, a separate register is required for each line of the display to store the corresponding pixel activation time value. In the embodiment for pixel-by-pixel activation time control, a separate register is required for each pixel within the display to store the corresponding pixel activation time value. In the embodiment for line segment-by-line segment activation time control, a separate register is required for each line segment within the display to store the corresponding pixel activation time value. Additionally, in the line segment-by-line segment embodiment, a number of registers can be provided for each line of the display to enable programming of how the corresponding line of the display is to be segmented. In view of the foregoing, it should be appreciated that the number of registers required to store the pixel activation time data for the display is dependent upon the level of brightness uniformity control capability provided, wherein the pixel-by-pixel control capability requires the largest number of registers, the line-by-line control capability requires the smallest number of registers.

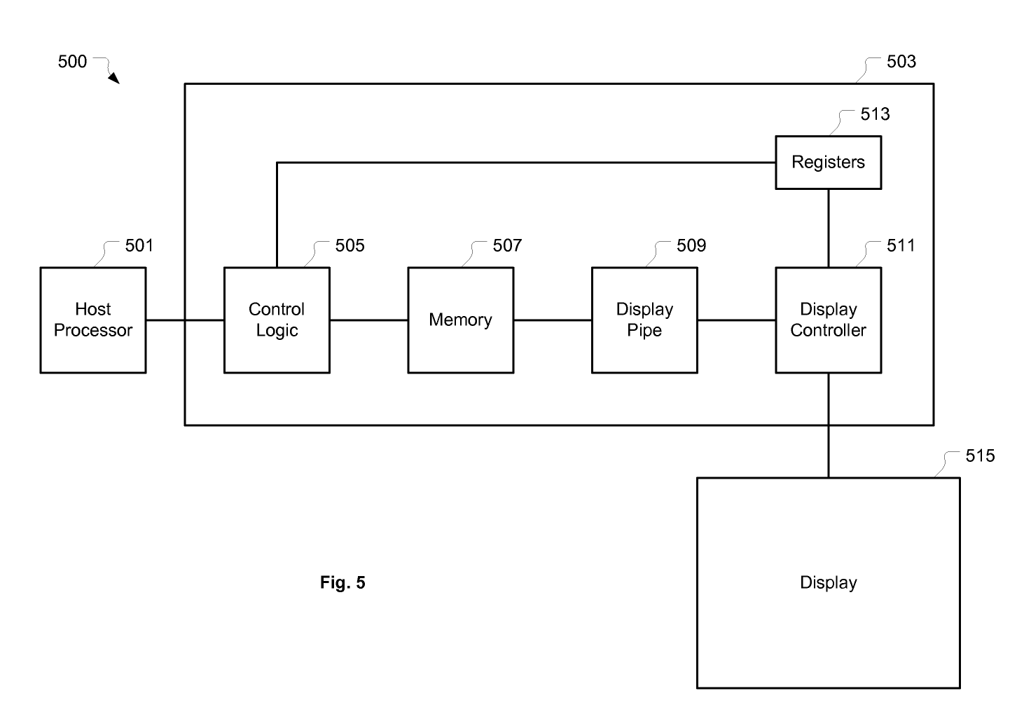

FIG. 5 is an illustration showing a system 500 for implementing pixel activation time based brightness uniformity control, in accordance with one embodiment of the present invention. The system 500 includes a host processor 501 in communication with a graphics engine 503 defined to drive a display 515. The graphics engine 503 includes control logic 505 for receiving digital image display data and instructions from the host processor 501. The control logic 505 is defined to store the digital image to be displayed in a memory 507. A display pipe 509 is defined to read the digital image data from the memory 507 is a prescribed manner and present the digital image data to a display controller 511. The display controller 511 is defined to transmit control signals to the display 515 to cause the digital image data to be rendered by the display 515. The type of display 515 can vary from one embodiment to another. For example, the display 515 may be an LCD display, a CRT display, a projector, etc. The display controller 511 is defined to be compatible with the specific type of display 515 to which it is connected.

The system 500 further includes registers 513 for storing the pixel activation time control values required to implement the pixel activation time based brightness uniformity control method. The control logic 505 is defined to enable programming of the pixel activation time control values in the appropriate registers 513. More specifically, depending on the particular embodiment, the display duration for lines, pixels, or line segments can be programmed into corresponding registers 513.

The display controller 511 is defined to access the pixel activation time control values in the registers 513, as appropriate, to implement the pixel activation time based brightness uniformity control method. In one embodiment, logic for implementing the pixel activation time based brightness uniformity control method is defined within the display controller 511. In another embodiment, the required logic is defined across both the display controller 511 and the display 515.

Conventional display controllers are not defined to provide separate control of individual lines on a display. For example, a conventional display controller can be programmed to refresh a display at a given frequency, e.g., 60 Hz, such that each pixel within the display is turned on for the same amount of time as the display is scanned. In the embodiment where brightness uniformity is controlled on a line-by-line basis, the display controller 511 of the present invention is defined to include logic for controlling how long each line of the display 515 is to be turned on during scanning of the display 515. For line-by-line control, the required logic may be confined to the display controller 511, without modification of or addition to the logic within the display 515 itself. In the embodiments where brightness uniformity is controlled on either a line segment-by-line segment basis or pixel-by-pixel basis, required logic may be defined within both the display controller 511 and the display 515. For example, if the display 515 is pixel based, e.g., CRT monitor, the pixel display control may be provided within the display 515 itself and may involve modification of the display driver circuits.

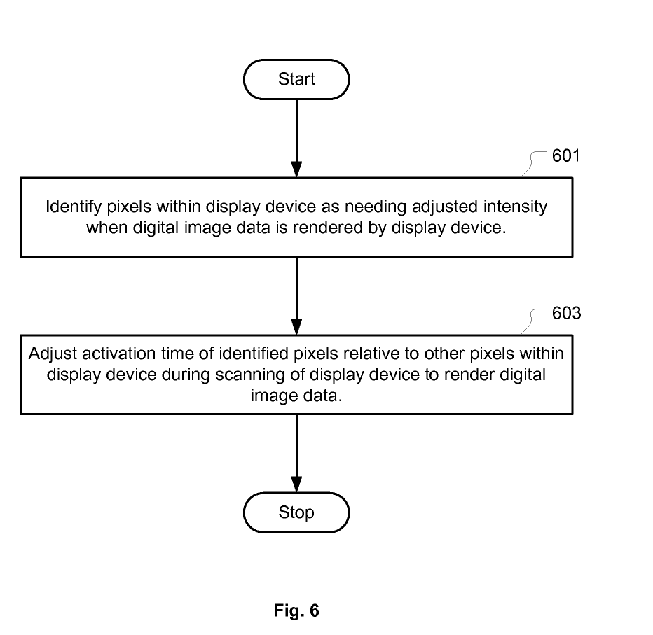

FIG. 6 is an illustration showing a flowchart of a method for displaying image data, in accordance with one embodiment of the present invention. The method includes an operation 601 for identifying a number of pixels within a display device as needing an intensity adjustment when digital image data is rendered by the display device. In one embodiment, the number of pixels needing intensity adjustment are identified based on proximity to a light source of the display device. The method also includes an operation 603 for adjusting an activation time of the number of identified pixels relative to other pixels within the display device, during scanning of the display device to render the digital image data. The adjusted activation time causes the number of identified pixels to be visually perceived as having a correspondingly adjusted intensity. The adjusted activation time to be applied to the number of identified pixels can be programmed prior to scanning of the display device to render the digital image data.

In one embodiment, operation 601 for identifying the number of pixels needing intensity adjustment and operation 603 for adjusting the activation time of the number of identified pixels are performed on a pixel-by-pixel basis. In another embodiment, operation 601 for identifying the number of pixels needing intensity adjustment and operation 603 for adjusting the activation time of the number of identified pixels are performed on a line-by-line basis, wherein each line represents a complete line of pixels defined across the width of the display device. In another embodiment, operation 601 for identifying the number of pixels needing intensity adjustment and operation 603 for adjusting the activation time of the number of identified pixels are performed on a line segment-by-line segment basis, wherein each line segment represents a portion of a line of pixels defined across the width of the display device.

It should be appreciated that the method for providing pixel activation time based brightness uniformity control, as described herein, does not involve lowering of the intensity of the overall displayed image to achieve uniformity. Rather, the method described herein adjusts the perceived intensity of particular display areas of interest by adjusting the period of time that those particular display areas are turned on during scanning of the display. Also, it should be appreciated that the method for providing pixel activation time based brightness uniformity control, as described herein, does not involve modification of the digital data to be displayed or of the analog brightness of the display.

One skilled in the art will appreciate that the circuitry required to provide pixel activation time based brightness uniformity control, as described herein, can be defined on a semiconductor chip using logic gates configured to provide the required functionality. For example, a hardware description language (HDL) can be employed to synthesize hardware and a layout of the logic gates for providing the necessary functionality described herein.

With the above embodiments in mind, it should be understood that the present invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

What is claimed is:

1. A display controller, comprising:
logic defined to control an activation time of separate pixels within a display device during scanning of the display device to render digital image data, wherein an increased activation time of a given pixel causes the given pixel to be visually perceived as having an increased intensity, and a decreased activation time of the given pixel causes the given pixel to be visually perceived as having a decreased intensity.

2. A display controller as recited in claim 1, further comprising:
logic defined to access a number of registers within which a prescribed activation time is to be stored for each pixel within the display device.

3. A display controller as recited in claim 1, wherein the logic is defined to collectively control an activation time of pixels within each line of the display device such that different lines of the display device can be activated for different amounts of time, wherein each line of the display device represents a complete line of pixels defined across a width of the display device.

4. A display controller as recited in claim 3, further comprising:
logic defined to access a number of registers within which a prescribed activation time is to be stored for each line of the display device.

5. A display controller as recited in claim 1, wherein the logic is defined to collectively control an activation time of pixels within separate line segments of the display device such that different line segments of the display device can be activated for different amounts of time, wherein each line segment of the display device represents a portion of a line of pixels defined across a width of the display device.

6. A display controller as recited in claim 5, wherein a line segment can range in size from one pixel to a total number of pixels within the line of pixels.

7. A display controller as recited in claim 5, further comprising:
logic defined to access a number of registers within which a prescribed activation time is to be stored for each line segment of the display device.

8. A display controller as recited in claim 1, wherein the display device is either a liquid crystal display (LCD) device, a cathode ray tube (CRT) display device, or a projector display device.

9. A graphics engine, comprising:
a display controller defined to separately control an activation time of each line within a display device relative to other lines within the display device during scanning of the display device to render digital image data, wherein an increased activation time of a given line causes the given line to be visually perceived as having an increased intensity, and a decreased activation time of the given pixel causes the given pixel to be visually perceived as having a decreased intensity.

10. A graphics engine as recited in claim 9, further comprising:
a number of registers defined to store activation times to be applied to the number of lines within the display device, wherein each of the number of registers is assigned to a different one of the number of lines within the display device.

11. A graphics engine as recited in claim 10, further comprising:
control logic defined to enable each of the number of registers to be programmed with an appropriate activation time.

12. A graphics engine as recited in claim 9, wherein the display device is a liquid crystal display (LCD).

13. A method for displaying image data, comprising:
identifying a number of pixels within a display device as needing an adjusted intensity when digital image data is rendered by the display device; and
adjusting an activation time of the number of identified pixels relative to other pixels within the display device during scanning of the display device to render the digital image data, wherein the adjusted activation time causes the number of identified pixels to be visually perceived as having a correspondingly adjusted intensity.

14. A method for displaying image data as recited in claim 13, wherein the number of pixels needing adjusted intensity are identified based on proximity to a light source of the display device.

15. A method for displaying image data as recited in claim 13, wherein identifying the number of pixels needing adjusted intensity and adjusting the activation time of the number of identified pixels is performed on a pixel-by-pixel basis.

16. A method for displaying image data as recited in claim 13, wherein identifying the number of pixels needing adjusted intensity and adjusting the activation time of the number of identified pixels is performed on a line-by-line basis, wherein each line represents a complete line of pixels defined across a width of the display device.

17. A method for displaying image data as recited in claim 13, wherein identifying the number of pixels needing adjusted intensity and adjusting the activation time of the number of identified pixels is performed on a line segment-by-line segment basis, wherein each line segment represents a portion of a line of pixels defined across a width of the display device.

18. A method for displaying image data as recited in claim 13, further comprising:
programming the activation time to be applied to the number of identified pixels prior to scanning of the display device to render the digital image data.

19. A method for displaying image data as recited in claim 13, wherein the activation time of each of the number of identified pixels is adjusted relative to other pixels within the display device during scanning of the display device to render the digital image data without modification of the digital image data.

20. A method for displaying image data as recited in claim 13, wherein the activation time of each of the number of identified pixels is adjusted relative to other pixels within the display device during scanning of the display device to render the digital image data without modification of an analog brightness setting of the display device.
